(19) United States
(12) Patent Application Publication
(10) Pub. No.: US 2025/0364643 A1
(43) Pub. Date: Nov. 27, 2025

(54) BATTERY CELL

(71) Applicant: TOYOTA JIDOSHA KABUSHIKI KAISHA, Toyota-shi, Aichi-ken (JP)

(72) Inventors: Tomoya MESUDA, Nisshin-shi, Aichi-ken (JP); Seigo FUJISHIMA, Miyoshi-shi, Aichi-ken (JP); Yoshiro OBAYASHI, Toyota-shi, Aichi-ken (JP); Kosuke SUZUKI, Toyota-shi, Aichi-ken (JP); Takeru HARA, Toyota-shi, Aichi-ken (JP); Satoshi MORIYAMA, Nagoya-shi, Aichi-ken (JP); Kenta MIYAHARA, Toyohashi-shi, Aichi-ken (JP)

(21) Appl. No.: 18/963,809

(22) Filed: Nov. 29, 2024

(30) Foreign Application Priority Data
Dec. 14, 2023 (JP) 2023-211362

(51) Int. Cl. H01M 50/131; B60K 1/04; H01M 50/595

(52) U.S. Cl. CPC H01M 50/131; H01M 50/595; B60K 1/04; B60K 2001/0438; H01M 2220/20

(57) ABSTRACT

A battery cell includes: an elongated electrode body that is formed by laminating a positive electrode, a negative electrode, and a separator; a band-shaped tape that extends in a short direction of the electrode body and that is wound around an outer periphery of the electrode body; and a laminate film that seals the electrode body in a state in which the electrode body around which the tape is wound is accommodated therein, wherein a recess is provided at a portion of an adhesive surface, of the tape, that adheres to the electrode body, the recess being recessed more than other portions of the adhesive surface.

### CROSS-REFERENCE TO RELATED APPLICATION

This application is based on and claims priority under 35 USC 119 from Japanese Patent Application No. 2023-211362, filed on Dec. 14, 2023, the entire disclosure of which is incorporated by reference herein.

### BACKGROUND

### Technical Field

The present disclosure relates to a battery cell.

### Related Art

United States Patent Application Publication No. 2018/287184 discloses a battery module in which an electrode assembly is accommodated in a case. Furthermore, by surrounding an outer side of the electrode assembly (electrode body) with a heat-shrinkable protective layer, a structure is provided in which thermal expansion of the electrode assembly is suppressed.

As in the structure disclosed in United States Patent Application Publication No. 2018/287184, by winding an outer periphery of the electrode body with a tape or the like, the electrode body can be restrained. On the other hand, by winding a heat-shrinkable protective layer or the like on an outer peripheral side of the battery cell, there is a possibility that it will become more difficult for gas that is generated during charging and discharging to escape.

### SUMMARY

The present disclosure provides a battery cell that can be released gas during charging and discharging, while restraining an electrode body.

A battery cell according to a first aspect includes: an elongated electrode body that is formed by laminating a positive electrode, a negative electrode, and a separator; a band-shaped tape that extends in a short direction of the electrode body and that is wound around an outer periphery of the electrode body; and a laminate film that seals the electrode body in a state in which the electrode body around which the tape is wound is accommodated therein, wherein a recess is provided at a portion of an adhesive surface, of the tape, that adheres to the electrode body, the recess being recessed more than other portions of the adhesive surface.

In the battery cell according to the first aspect, the electrode body is formed in an elongated shape by laminating the positive electrode, the negative electrode, and the separator. Further, the tape is formed in a band shape, extends in the short direction of the electrode body, and is wound around the outer periphery of the electrode body. Moreover, the electrode body around which the tape is wound is sealed by the laminate film in a state in which it is accommodated in the laminate film. By winding the tape around the outer periphery of the electrode body in this manner, the electrode body can be restrained, and deviation of positions of the laminated electrodes can be suppressed.

Furthermore, the recess, which is recessed more than other portions of the adhesive surface, is provided at a portion of the adhesive surface, of the tape, that adheres to the electrode body. As a result, at the recess, since a restraining force with respect to the electrode body is weaker than at the other portions, gas that has been generated at the electrode body can be released without stagnating at an interior thereof.

A battery cell according to a second aspect is the battery cell according to the first aspect, wherein the recess is spaced apart from a surface of the electrode body in an unloaded state.

In the battery cell according to the second aspect, since the recess of the tape is spaced apart from the surface of the electrode body in an unloaded state, gas at the interior of the electrode body can freely move at this portion. It should be noted that an “unloaded state”, as used herein, is a concept that broadly includes states excluding those in which the electrode body is expanded by gas that has been generated at the interior of the electrode body, and does not refer to only a state in which no external force is applied to the electrode body and the tape at all.

A battery cell according to a third aspect is the battery cell according to the second aspect, wherein plural tapes are provided at intervals in a longitudinal direction of the electrode body.

In the battery cell according to the third aspect, since plural tapes are provided at intervals in the longitudinal direction of the electrode body, even in a case in which the electrode body has an elongated shape, deviation of positions of the laminated electrodes can be effectively suppressed.

A battery cell according to a fourth aspect is the battery cell according to the third aspect, wherein at least one of the plural tapes is provided at a longitudinal direction central portion of the electrode body.

In the battery cell according to the fourth aspect, by providing the tape at the longitudinal direction central portion of the electrode body, which undergoes the most thermal expansion, thermal expansion of the battery cell can be suppressed.

A battery cell according to a fifth aspect is the battery cell according to the fourth aspect, wherein plural recesses are provided, and at least a portion of recesses of adjacent tapes overlap with each other as viewed from the longitudinal direction of the electrode body.

In the battery cell according to the fifth aspect, at least a portion of the recesses of adjacent tapes overlap with each other as viewed from the longitudinal direction of the electrode body. As a result, gas that has been generated at the central portion of the electrode body is more likely to escape in the longitudinal direction.

As explained above, according to the battery cell of the present disclosure, it is possible to be released gas during charging and discharging, while restraining the electrode body.

### BRIEF DESCRIPTION OF THE DRAWINGS

Exemplary embodiments of the present disclosure will be described in detail based on the following figures, wherein:

FIG. 1 is a schematic plan view illustrating a main portion of a vehicle to which a battery pack including a battery cell according to an exemplary embodiment has been applied;

FIG. 2 is a schematic perspective view of a battery module accommodating the battery cell according to the exemplary embodiment;

FIG. 3 is a plan view showing a state in which an upper lid of the battery module has been removed;

FIG. 4 is a schematic view in which the battery cell according to the exemplary embodiment is viewed from a thickness direction;

FIG. 5 is a schematic view in which an electrode body according to the exemplary embodiment is viewed from a thickness direction;

FIG. 6 is a cross-sectional view taken along line 6-6 in FIG. 5; and

FIG. 7 is a schematic view in which an electrode body according to a modified example is viewed from a thickness direction.

### DETAILED DESCRIPTION

A battery module 11 including a battery cell 20 according to an exemplary embodiment will be explained with reference to the drawings.

### (Overall Configuration of Vehicle 100)

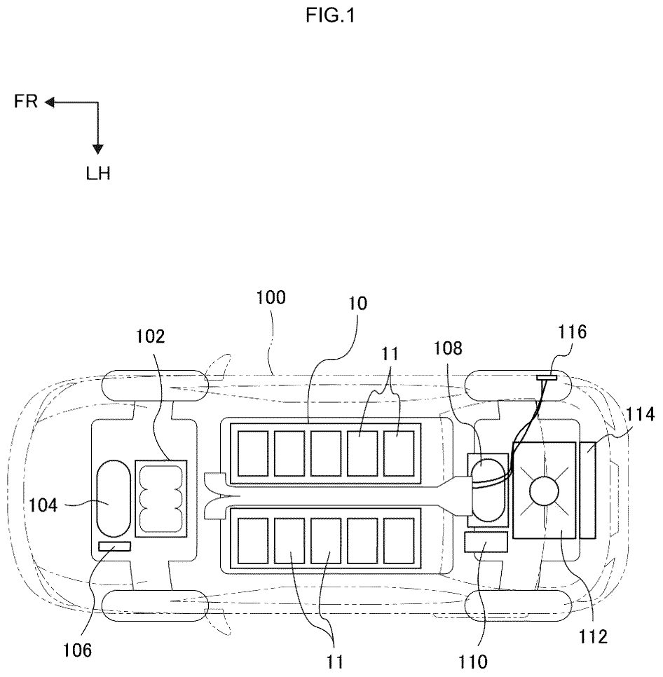

FIG. 1 is a schematic plan view illustrating a main portion of a vehicle 100 to which a battery pack 10 including the battery module 11 according to the present exemplary embodiment has been applied. As shown in FIG. 1, the vehicle 100 is an electric vehicle (battery electric vehicle (BEV)) in which the battery pack 10 is mounted under a floor. It should be noted that arrow UP, arrow FR, and arrow LH in the respective drawings respectively indicate an upper side in a vehicle up-down direction, a front side in a vehicle front-rear direction, and a left side in a vehicle width direction. In cases in which explanation is given using front-rear, left-right, and up-down directions, unless otherwise specified, these indicate front and rear in the vehicle front-rear direction, left and right in the vehicle width direction, and up and down in the vehicle up-down direction.

As an example, in the vehicle 100 of the present exemplary embodiment, a DC/DC converter 102, an electric compressor 104, and a positive temperature coefficient (PTC) heater 106 are arranged further toward a vehicle front side than the battery pack 10. Furthermore, a motor 108, a gear box 110, an inverter 112, and a charger 114 are arranged further toward a vehicle rear side than the battery pack 10.

A DC current that has been output from the battery pack 10 is adjusted in voltage by the DC/DC converter 102, and thereafter supplied to the electric compressor 104, the PTC heater 106, the inverter 112, and the like. Furthermore, by supplying electric power to the motor 108 via the inverter 112, rear wheels rotate to drive the vehicle 100.

A charging port 116 is provided at a right side portion of a rear portion of the vehicle 100, and by connecting a charging plug of an external charging facility, which is not illustrated in the drawings, from the charging port 116, electric power can be stored in the battery pack 10 via the vehicle-mounted charger 114.

It should be noted that an arrangement, structure and the like of the respective components configuring the vehicle 100 are not limited to the configuration described above. For example, the present disclosure may be applied to a hybrid vehicle (HV) or a plug-in hybrid vehicle (plug-in hybrid electric vehicle (PHEV)) at which an engine is mounted. Further, in the present exemplary embodiment, although the vehicle is configured as a rear-wheel drive vehicle in which the motor 108 is mounted at the rear portion of the vehicle, there is no limitation thereto; the vehicle may be configured as a front-wheel drive vehicle in which the motor 108 is mounted at the front portion of the vehicle, and a pair of motors 108 may also be mounted at the front and rear of the vehicle. Furthermore, the vehicle may also be provided with in-wheel motors at the respective wheels.

The battery pack 10 is configured to include plural battery modules 11. In the present exemplary embodiment, as an example, ten battery modules 11 are provided. Specifically, five battery modules 11 are arranged in the vehicle front-rear direction at the right side of the vehicle 100, and five battery modules 11 are arranged in the vehicle front-rear direction at the left side of the vehicle 100. Furthermore, each of the battery modules 11 are electrically connected to each other.

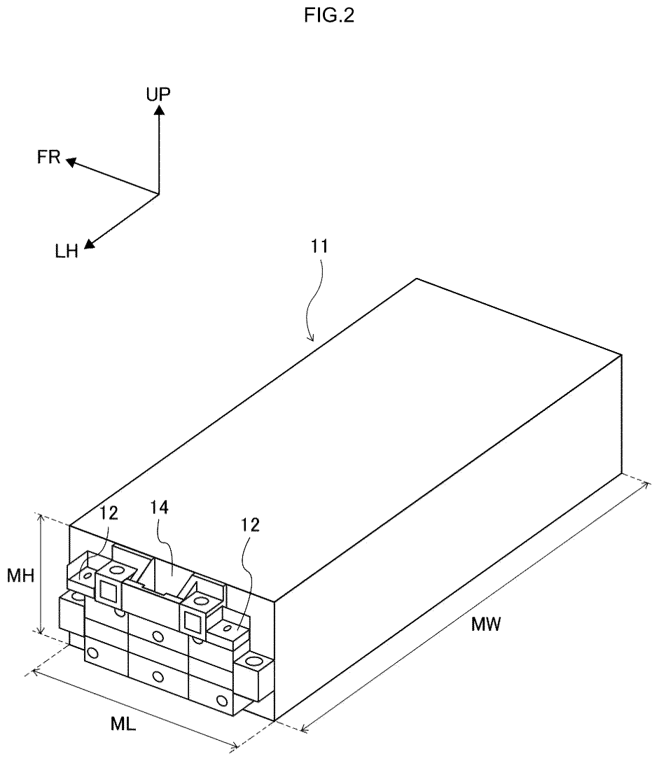

FIG. 2 is a schematic perspective view of the battery module 11. As shown in FIG. 2, the battery module 11 is formed in a substantially rectangular parallelepiped shape having a longitudinal direction along the vehicle width direction. Furthermore, a case 13 of the battery module 11 is formed of an aluminum alloy. For example, the case 13 of the battery module 11 is formed by joining aluminum die-casting to both end portions of an extruded material of an aluminum alloy by laser welding or the like.

A pair of voltage terminals 12 and a connector 14 are provided at both vehicle width direction end portions of the battery module 11. A flexible printed circuit board 21, which will be described later, is connected to the connector 14. Furthermore, bus bars, which are not illustrated in the drawings, are welded to both vehicle width direction end portions of the battery module 11.

A length MW of the battery module 11 in the vehicle width direction is, for example, from 350 mm to 600 mm, a length ML thereof in the vehicle front-rear direction is, for example, from 150 mm to 250 mm, and a height MH thereof in the vehicle up-down direction is, for example, from 80 mm to 110 mm.

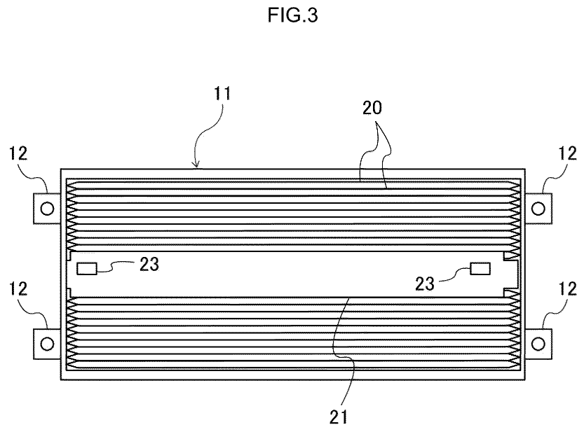

FIG. 3 is a plan view showing a state in which an upper lid of the battery module 11 has been removed. As shown in FIG. 3, a battery cell group in which plural battery cells 20 are arranged is accommodated at an interior of the battery module 11. In the present exemplary embodiment, as an example, 24 battery cells 20 are arranged in the vehicle front-rear direction and adhered to each other.

A flexible printed circuit board (flexible printed circuit (FPC)) 21 is arranged on the battery cells 20. The flexible printed circuit board 21 is formed in a band shape with a longitudinal direction thereof along the vehicle width direction, and thermistors 23 are respectively provided at both end portions of the flexible printed circuit board 21. The thermistors 23 are not adhered to the battery cells 20 and are configured to be pressed toward a battery cell 20 side by the upper lid of the battery module 11.

Furthermore, one or more cushioning plates, which are not illustrated in the drawings, are accommodated at the interior of the battery module 11. For example, the cushioning plates are thin plate-shaped members that are elastically deformable, and are arranged between adjacent battery cells 20 with a thickness direction thereof along an arrangement direction of the battery cells 20. In the present exemplary embodiment, as an example, the cushioning plates are respectively arranged at both longitudinal direction end portions and a longitudinal direction central portion of the battery module 11.

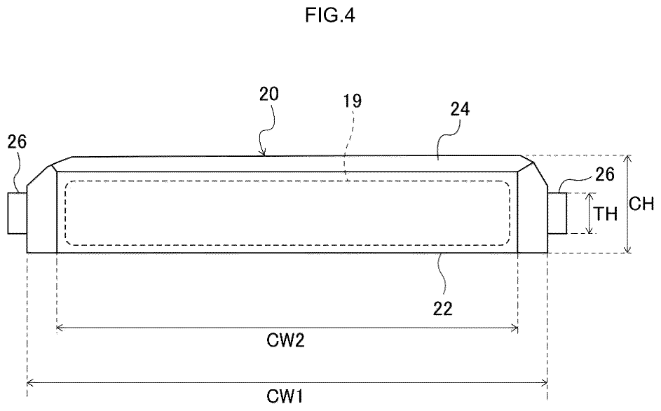

FIG. 4 is a schematic view in which a battery cell 20 that is accommodated in the battery module 11 is viewed from a thickness direction thereof. As shown in FIG. 4, the battery cell 20 is formed in a substantially rectangular plate shape, and an elongated electrode body 19 is accommodated at an interior thereof. The electrode body 19 is configured by laminating a positive electrode, a negative electrode, and a separator, and is sealed by a laminate film 22.

In the present exemplary embodiment, as an example, the embossed sheet-shaped laminate film 22 is folded and bonded to thereby form an accommodation portion for the electrode body 19. It should be noted that, although both structures of a single-cup embossing structure in which the embossing is at one location and a double-cup embossing structure in which the embossing is at two locations can be adopted, in the present exemplary embodiment, the structure is a single-cup embossing structure having a draw depth of from about 8 mm to about 10 mm.

Upper ends of both longitudinal direction end portions of the battery cell 20 are bent. Furthermore, an upper end portion of the battery cell 20 is bent, and a fixing tape 24 is wound around the upper end portion of the battery cell 20 along the longitudinal direction.

In this regard, terminals (tabs) 26 are respectively provided at both longitudinal direction end portions of the battery cell 20. In the present exemplary embodiment, as an example, the terminals 26 are provided at positions that are offset downward from a center of the battery cell 20 in the up-down direction. The terminals 26 are connected to the bus bars, which are not illustrated in the drawings, by laser welding or the like.

A length CW1 of the battery cell 20 in the vehicle width direction is, for example, from 530 mm to 600 mm, a length CW2 of a region in which the electrode body 19 is accommodated is, for example, from 500 mm to 520 mm, and a height CH of the battery cell 20 is, for example, from 80 mm to 110 mm. Consequently, the battery cell 20 is formed in an elongated shape, and directions of the lengths CW1 and CW2 are along the longitudinal direction.

Furthermore, a thickness of the battery cell 20 is from 7.0 mm to 9.0 mm, and a height TH of the terminals 26 is from 40 mm to 50 mm.

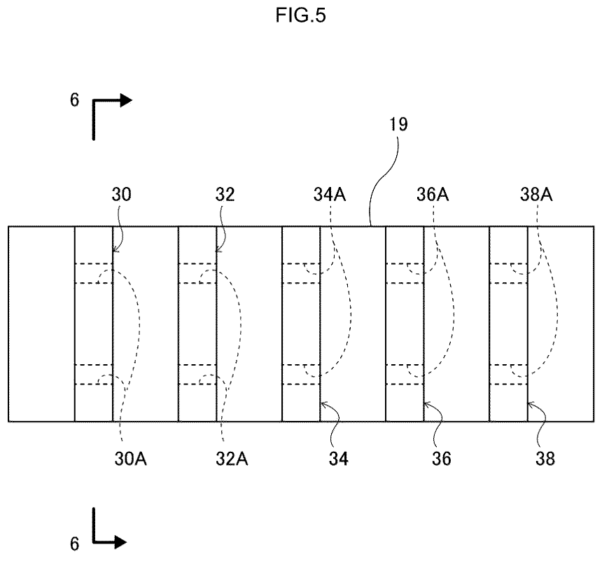

FIG. 5 is a schematic diagram in which the electrode body 19 according to the exemplary embodiment is viewed from the thickness direction. As shown in FIG. 5, the electrode body 19 of the present exemplary embodiment is formed in an elongated shape by laminating the positive electrode, the negative electrode, and the separator.

Although not illustrated in the drawings, the positive electrode, the negative electrode, and the separator have structures that are used in general secondary batteries. For example, the negative electrode is configured to include a current collector configured by a metal foil such as a copper foil or the like, and a negative electrode active material held by the current collector. Accompanying charging and discharging, the negative electrode active material occludes lithium ions, which serve as charge carriers, from a nonaqueous electrolytic solution, and release the lithium ions into the nonaqueous electrolytic solution. Although a silicon-containing material such as a silicon-based carbon composite material or the like is used as the negative electrode active material of the present exemplary embodiment, there is no limitation thereto. For example, known negative electrode active materials such as artificial graphite, lithium alloys (LiXM) and the like may be used as the negative electrode active material. It should be noted that M in LiXM is C, Si, Sn, Sb, Al, Mg, Ti, Bi, Ge, Pb, P or the like, and that X is a natural number. Furthermore, a negative electrode active material layer formed of the negative electrode active material may contain a known binder such as a styrene-butadiene copolymer or the like.

Furthermore, for example, the positive electrode includes a current collector formed of an aluminum foil or the like, and a positive electrode active material. The positive electrode active material releases lithium ions into the nonaqueous electrolytic solution or occludes lithium ions from the nonaqueous electrolytic solution. As the positive electrode active material, a known positive electrode active material such as LiNiO2, LiNi1/3Co1/3Mn1/3O2 or the like is used. Furthermore, carbon black, trilithium phosphate, and a known binder may be further contained.

The separator is a sheet-shaped member that electrically insulates the positive electrode and the negative electrode and provides a transfer path for lithium ions between the positive electrode active material and the negative electrode active material. Examples of the separator include porous membranes formed of polyethylene, polypropylene or the like. It should be noted that the separator may have a single-layer structure, or may have a multilayer structure.

In the present exemplary embodiment, band-shaped tapes 30, 32, 34, 36, and 38 are wound around an outer periphery of the electrode body 19. The tapes 30, 32, 34, 36, and 38 are provided at intervals in the longitudinal direction of the electrode body 19, and in the present exemplary embodiment, as an example, five tapes are provided at equal intervals at the outer periphery of the electrode body 19.

The tape 34 is provided at a longitudinal direction central portion of the electrode body 19, and extends in a short direction of the electrode body 19. Furthermore, plural recesses 34A are provided at the tape 34. In the present exemplary embodiment, as an example, two recesses 34A are provided at one surface of the electrode body 19, and two recesses 34A are similarly provided at the other surface.

The tape 32 and the tape 36 are provided at intervals on both sides of the tape 34. For example, a distance between the tape 34 and the tape 32 and a distance between the tape 34 and the tape 36 are equal distances. Furthermore, plural recesses 32A are provided at the tape 32, and plural recesses 36A are provided at the tape 36. Specifically, two recesses 32A and two recesses 36A are provided at the one surface of the electrode body 19, and two recesses 32A and two recesses 36A are similarly provided at the other surface of the electrode body 19.

The tape 30 is provided on an opposite side of the tape 32 from the tape 34. Furthermore, the tape 38 is provided on an opposite side of the tape 36 from the tape 34. Plural recesses 30A are provided at the tape 30, and plural recesses 38A are provided at the tape 38. Specifically, two recesses 30A and two recesses 38A are provided at the one surface of the electrode body 19, and two recesses 30A and two recesses 38A are similarly provided at the other surface of the electrode body 19.

In this regard, at least a portion of the recesses of adjacent tapes overlap as viewed from the longitudinal direction of the electrode body 19. In the present exemplary embodiment, as an example, the recesses 30A, the recesses 32A, the recesses 34A, the recesses 36A, and the recesses 38A overlap with each other as viewed from the longitudinal direction of the electrode body 19. Although not illustrated in the drawings, the recesses that are formed at the other surface (back surface) of the electrode body 19 similarly overlap with each other as viewed from the longitudinal direction of the electrode body 19.

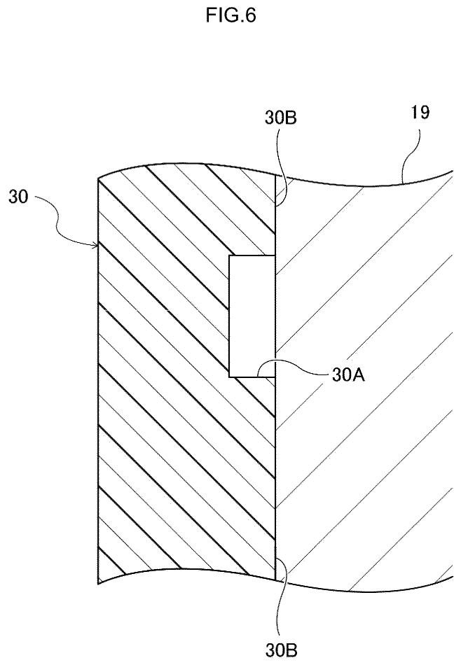

FIG. 6 is a cross-sectional view taken along line 6-6 in FIG. 5. As shown in FIG. 6, a recess 30A and an adhesive portion 30B are formed at an adhesive surface of the tape 30 that faces the electrode body 19. The adhesive portion 30B is adhered to a surface of the electrode body 19. Furthermore, the recess 30A is recessed more than other portions (the adhesive portion 30B), and is spaced apart from the surface of the electrode body 19 in an unloaded state. That is to say, the recess 30A configures a non-adhesive portion that is not adhered to the surface of the electrode body 19.

As a result, the recess 30A and the adhesive portion 30B are alternately provided in an extending direction of the tape 30. Furthermore, in a similar manner, at each of the other tapes 32, 34, 36, and 38 illustrated in FIG. 5 as well, a recess and an adhesive portion are alternately provided in an extending direction of the tape, and the recess configures a non-adhesive portion.

### (Operation)

Next, operation of the battery cell 20 according to the present exemplary embodiment will be explained.

In the battery cell 20 according to the present exemplary embodiment, the electrode body 19 is formed in an elongated shape by laminating the positive electrode, the negative electrode, and the separator. Furthermore, the tape 30, the tape 32, the tape 34, the tape 36, and the tape 38 are formed in band shapes, extend in the short direction of the electrode body 19, and are wound around the outer periphery of the electrode body 19. Furthermore, the electrode body 19 around which the tape 30, the tape 32, the tape 34, the tape 36, and the tape 38 are wound is sealed in a state of being accommodated in the laminate film 22. By winding the tape 30, the tape 32, the tape 34, the tape 36, and the tape 38 around the outer periphery of the electrode body 19 in this manner, the electrode body 19 can be restrained, and deviation of positions of the laminated electrodes can be suppressed.

Further, the recesses 30A, the recesses 32A, the recesses 34A, the recesses 36A, and the recesses 38A, which are recessed more than other portions, are respectively provided at portions of adhesive surfaces, which are adhered to the electrode body 19, of the tape 30, the tape 32, the tape 34, the tape 36, and the tape 38. As a result, at the recesses 30A, the recesses 32A, the recesses 34A, the recesses 36A, and the recesses 38A, since a restraining force with respect to the electrode body 19 is weaker than at the other portions, gas that has been generated at the electrode body 19 can be released without stagnating at an interior thereof.

Furthermore, in the present exemplary embodiment, since the recesses 30A, the recesses 32A, the recesses 34A, the recesses 36A, and the recesses 38A that are respectively formed at the tape 30, the tape 32, the tape 34, the tape 36, and the tape 38 are spaced apart from the surface of the electrode body 19 in an unloaded state, gas at the interior of the electrode body 19 can freely move at these portions.

Moreover, in the present exemplary embodiment, since plural tapes are provided at intervals in the longitudinal direction of the electrode body 19, even in the case that the electrode body 19 has an elongated shape, deviation of positions of the laminated electrodes can be effectively suppressed.

Further, in the present exemplary embodiment, by providing the tape 34 at the longitudinal direction central portion of the electrode body 19, which undergoes the most thermal expansion, thermal expansion of the battery cell 20 can be suppressed.

Furthermore, in the present exemplary embodiment, at least a portion of the recesses of adjacent tapes overlap with each other as viewed from the longitudinal direction of the electrode body 19. As a result, gas that has been generated at the central portion of the electrode body 19 is more likely to escape in the longitudinal direction.

In particular, in the present exemplary embodiment, the recesses 30A, the recesses 32A, the recesses 34A, the recesses 36A, and the recesses 38A coincide with each other as viewed from the longitudinal direction of the electrode body 19. As a result, gas that has been generated at the central portion of the electrode body 19 is more likely to escape in the longitudinal direction by passing through an interior of a portion at which the recesses are formed. As a result, in the battery cell 20 of the present exemplary embodiment, it is possible to be released gas during charging and discharging, while restraining the electrode body 19.

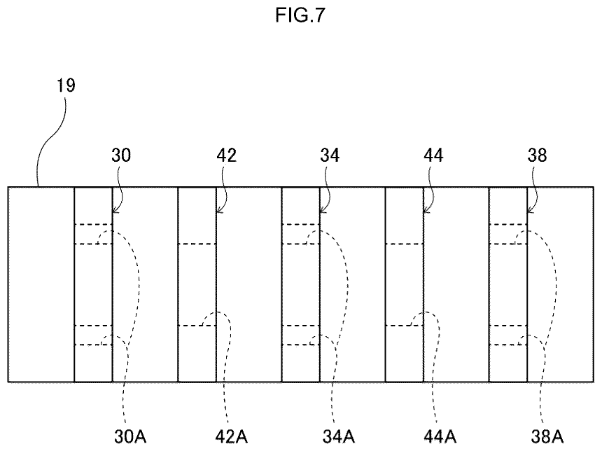

It should be noted that, although the recesses 30A, the recesses 32A, the recesses 34A, the recesses 36A, and the recesses 38A are provided at the same positions in the longitudinal direction of the electrode body 19 in the above exemplary embodiment as shown in FIG. 5, there is no limitation thereto. For example, the structure of the modified example shown in FIG. 7 may be adopted.

### Modified Example

FIG. 7 is a schematic view in which an electrode body 19 according to a modified example is viewed from a thickness direction. As shown in FIG. 7, in the present modified example, a tape 42 is provided between the tape 30 and the tape 34 in place of the tape 32. Furthermore, a tape 44 is provided between the tape 34 and the tape 38 in place of the tape 36.

A recess 42A is provided at the tape 42. The recess 42A is formed to be wider than the recesses 30A of the tape 30, and is provided at a position that does not overlap with the recesses 30A as viewed from the longitudinal direction of the electrode body 19. It should be noted that one recess 42A is provided at one surface of the electrode body 19, and that one recess 42A is provided at the other surface of the electrode body 19.

A recess 44A is provided at the tape 44. The recess 44A is formed to be wider than the recesses 30A of the tape 30, and is provided at a position that does not overlap with the recesses 30A as viewed from the longitudinal direction of the electrode body 19. It should be noted that one recess 44A is provided at the one surface of the electrode body 19, and that one recess 44A is provided at the other surface of the electrode body 19.

By providing the recesses at different positions in the longitudinal direction of the electrode body 19 as in the present modified example, a path of gas that has been generated at the electrode body 19 can be changed. Furthermore, since the adhesive portion at which the tape and the electrode body are adhered and the non-adhesive portion are alternately arranged in the longitudinal direction of the electrode body 19, it is possible to suppress local reduction in the restraining force with respect to the electrode body 19.

Although the battery cell 20 according to the exemplary embodiment and the modified example has been described above, there is no limitation thereto, and it goes without saying that the battery cell can be implemented in various forms in a range that does not depart from the gist of the present disclosure. For example, widths of the tapes that are wound around the electrode body 19 may be changed, and the widths of the tapes may be varied between a central portion and an edge portions in the longitudinal direction of the electrode body 19.

Furthermore, one tape having a wide width may be wound around the electrode body 19. In this case, by providing the recesses so that gas can easily escape at the adhesive surface of the tape, it is possible to be released gas during charging and discharging, while restraining the electrode body, even in the case of a tape having a wide width.

Moreover, although a configuration has been provided, in the above exemplary embodiment, in which the recesses are spaced from the surface of the electrode body 19 in an unloaded state, there is no limitation thereto. For example, a configuration may be provided in which the recesses provided at the tapes contact the surface of the electrode body 19 in an unloaded state. Even in this case, since the restraining force with respect to the electrode body 19 is weaker at the recesses than at other portions, a path through which gas escapes can be established at the interiors of these portions.

With regard to the above exemplary embodiments, the following additional notes are further disclosed.

### (Additional Note 1)

A battery cell comprising:
an elongated electrode body that is formed by laminating a positive electrode, a negative electrode, and a separator;
a band-shaped tape that extends in a short direction of the electrode body and that is wound around an outer periphery of the electrode body; and
a laminate film that seals the electrode body in a state in which the electrode body around which the tape is wound is accommodated therein,
wherein a recess is provided at a portion of an adhesive surface, of the tape, that adheres to the electrode body, the recess being recessed more than other portions of the adhesive surface.

### (Additional Note 2)

The battery cell according to Additional Note 1, wherein the recess is spaced apart from a surface of the electrode body in an unloaded state.

### (Additional Note 3)

The battery cell according to Additional Note 1 or Additional Note 2, wherein a plurality of tapes are provided at intervals in a longitudinal direction of the electrode body.

### (Additional Note 4)

The battery cell according to Additional Note 3, wherein at least one of the plurality of tapes is provided at a longitudinal direction central portion of the electrode body.

### (Additional Note 5)

The battery cell according to Additional Note 3 or Additional Note 4, wherein:
a plurality of recesses are provided, and
at least a portion of recesses of adjacent tapes overlap with each other as viewed from the longitudinal direction of the electrode body.

### (Additional Note 6)

The battery cell according to Additional Note 3, wherein, in adjacent tapes, a recess of one tape and a recess of another tape are provided at different positions as viewed from the longitudinal direction of the electrode body.

What is claimed is:

1. A battery cell comprising:
an elongated electrode body that is formed by laminating a positive electrode, a negative electrode, and a separator;
a band-shaped tape that extends in a short direction of the electrode body and that is wound around an outer periphery of the electrode body; and
a laminate film that seals the electrode body in a state in which the electrode body around which the tape is wound is accommodated therein,
wherein a recess is provided at a portion of an adhesive surface, of the tape, that adheres to the electrode body, the recess being recessed more than other portions of the adhesive surface.

2. The battery cell according to claim 1, wherein the recess is spaced apart from a surface of the electrode body in an unloaded state.

3. The battery cell according to claim 1, wherein a plurality of tapes are provided at intervals in a longitudinal direction of the electrode body.

4. The battery cell according to claim 3, wherein at least one of the plurality of tapes is provided at a longitudinal direction central portion of the electrode body.

5. The battery cell according to claim 4, wherein:
a plurality of recesses are provided, and
at least a portion of recesses of adjacent tapes overlap with each other as viewed from the longitudinal direction of the electrode body.

6. The battery cell according to claim 3, wherein, in adjacent tapes, a recess of one tape and a recess of another tape are provided at different positions as viewed from the longitudinal direction of the electrode body.
